(19) United States
(12) Patent Application Publication
(10) Pub. No.: US 2023/0353016 A1
(43) Pub. Date: Nov. 2, 2023

(54) ROTARY MACHINE

(71) Applicant: MITSUBISHI HEAVY INDUSTRIES ENGINE & TURBOCHARGER, LTD., Sagamihara-shi, Kanagawa (JP)

(72) Inventors: Takashi SATO, Tokyo (JP); Naomichi SHIBATA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 17/794,950

(22) PCT Filed: Mar. 26, 2020
(86) PCT No.: PCT/JP2020/013734

§ 371 Date: Jul. 22, 2022

(51) Int. Cl. H02K 7/18

(52) U.S. Cl. CPC H02K 7/1823; H02K 2201/03

(57) ABSTRACT

This rotary machine is provided with: a rotor shaft; a compressor connected to the rotor shaft; a rotor connected to the rotor shaft on the upstream side, from the compressor, of the air-flow flowing to the compressor; a stator disposed so as to have a space from the outer circumferential part of the rotor; and a cover that covers the upstream side of the air-flow in the space between the stator and the rotor and that has an opening formed so as to connect the space with the upstream side, from the space, of the air-flow.

### TECHNICAL FIELD

The present disclosure relates to a rotary machine.

### BACKGROUND ART

A turbocharger that compresses intake air to an engine and supplies the compressed air to the engine is known. The turbocharger is composed of a rotor shaft (a rotary shaft) and a turbine and a compressor disposed at both ends of the rotor shaft. The turbocharger has a structure in which exhaust gas from the engine is supplied to the turbine to drive the turbine, thereby rotating the rotor shaft connected to the turbine and rotating the compressor to supply compressed air to the engine. However, since the exhaust gas from the engine is required to drive the turbocharger, there is a case where the amount of compressed air supplied from the turbocharger is insufficient when the engine is started or is at a low speed.

Therefore, an electrically assisted turbocharger provided with a motor (an electric motor) capable of rotating a rotor shaft of the turbocharger regardless of the presence or absence of the exhaust gas from an engine has been developed (for example, PTL 1). In an engine provided with an electrically assisted turbocharger, at a time of a low-load operation of the engine in which the exhaust gas that drives the turbocharger is insufficient, the turbocharger is driven by the motor to compensate for the lack of rotation of the turbocharger due to the lack of the exhaust gas.

In such an electrically assisted turbocharger, there is a case where the motor is disposed between a compressor and a turbine. However, there are problems such as an increase in response magnification in a primary bending mode and a decrease in motor efficiency due to the transfer of waste heat from the turbine to the motor. As a countermeasure, there is a case where a motor overhang structure is adopted in which a motor is mounted to a shaft extension portion in which an end portion on a compressor side of the rotor shaft extends.

### CITATION LIST

### Patent Literature

[PTL 1] PCT International Publication No. 2018/202668

### SUMMARY OF INVENTION

### Technical Problem

However, in the structure in which the motor is disposed at the shaft extension portion of the rotor shaft, there is a concern that the vibration characteristics may deteriorate due to an increase in the weight of an overhang portion and an increase in the length of the overhang portion.

The present disclosure has been made in view of the problem described above, and has an object to provide a rotary machine in which it is possible to suppress vibration of a rotor shaft.

### Solution to Problem

In order to solve the problem described above and to achieve the object, a rotary machine according to the present disclosure includes: a rotor shaft; a compressor part that is connected to the rotor shaft; a rotor part that is connected to the rotor shaft on an upstream side of a flow of air flowing through the compressor part with respect to the compressor part; a stator part that is provided to have a gap from an outer peripheral portion of the rotor part; and a cover part that covers the upstream side of the flow of the air of the gap between the stator part and the rotor part and that has an opening portion formed to make the gap and a location on the upstream side of the flow of the air with respect to the gap communicate with each other.

### Advantageous Effects of Invention

According to the present disclosure, it is possible to suppress vibration of the rotor shaft.

### BRIEF DESCRIPTION OF DRAWINGS

FIG. 1 is a schematic diagram showing an electrically assisted turbocharger according to the present disclosure.

FIG. 2 is a schematic diagram showing a first embodiment of a vibration damping structure according to the present disclosure.

FIG. 3 is a schematic diagram showing a second embodiment of the vibration damping structure according to the present disclosure.

FIG. 4 is a schematic diagram of a recess forming portion that is used in the vibration damping structure according to the present disclosure.

FIG. 5 is a schematic diagram showing a first example of the shape of a recess that is formed in the recess forming portion according to the present disclosure.

FIG. 6 is a schematic diagram showing a second example of the shape of the recess that is formed in the recess forming portion according to the present disclosure.

FIG. 7 is a schematic diagram showing a third example of the shape of the recess that is formed in the recess forming portion according to the present disclosure.

### DESCRIPTION OF EMBODIMENTS

### First Embodiment

(Electrically Assisted Turbocharger)

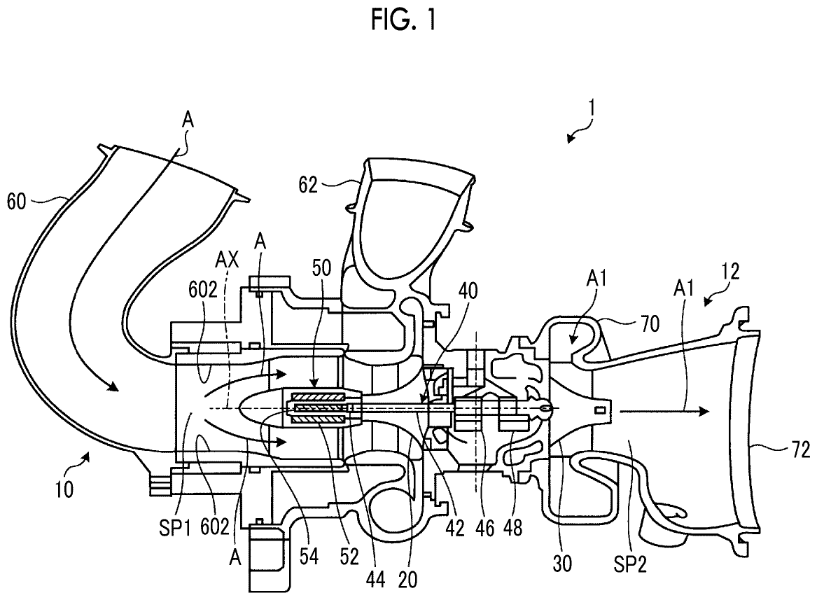

FIG. 1 is a schematic diagram showing an electrically assisted turbocharger according to the present disclosure. As shown in FIG. 1, an electrically assisted turbocharger 1 as a rotary machine includes a compressor housing 10, a turbine housing 12, a compressor part 20, a turbine part 30, a rotor shaft 40, and a motor part 50.

(Housing)

The compressor housing 10 is a housing having an internal space SP1 which accommodates the compressor part 20, the rotor shaft 40, and the motor part 50. The compressor housing 10 is provided with an intake air introduction path 60 and a compressed air discharge path 62, both of which communicate with the space SP1. The intake air introduction path 60 is provided on an upstream side in a flow direction of air A in the space SP1, and the compressed air discharge path 62 is provided on a downstream side in the flow direction of the air A in the space SP1. The compressor housing 10 is not limited to a structure that is composed of a single member, and may be composed of a plurality of housings.

The turbine housing 12 is a housing having an internal space SP2 that accommodates the turbine part 30. The turbine housing 12 is connected to the compressor housing 10. The turbine housing 12 is provided with an exhaust gas introduction path 70 and an exhaust gas discharge path 72, both of which communicate with the space SP2. The exhaust gas introduction path 70 is provided on the upstream side in a flow direction of an exhaust gas A1 in the space SP2, and the exhaust gas discharge path 72 is provided on the downstream side in the flow direction of the exhaust gas A1 in the space SP2.

The air A introduced from the intake air introduction path 60 is introduced into the space SP1 of the compressor housing 10, compressed by the compressor part 20, and supplied to an engine via the compressed air discharge path 62. The exhaust gas A1 from the engine is introduced into the space SP2 of the turbine housing 12 via the exhaust gas introduction path 70, and drives a turbine due to the rotation of the turbine part 30. After driving the turbine, the exhaust gas A1 is discharged through the exhaust gas discharge path 72.

(Rotor Shaft and Compressor Part)

The rotor shaft 40 is a member having a columnar shape, is provided inside the compressor housing 10 and the turbine housing 12, and extends along an axial direction AX. The rotor shaft 40 is divided into a base portion 42 and a shaft extension portion 44. The base portion 42 is formed as a portion having both ends to which the compressor part 20 and the turbine part 30 are fitted. Radial bearings 46 and 48 are provided at an intermediate portion between the location of the base portion 42, to which the compressor part 20 is connected, and the location of the base portion 42, to which the turbine part 30 is connected. A portion that extends along the rotor shaft 40 at the end portion on the side of the location to which the compressor part 20 is fitted, of the base portion 42 of the rotor shaft 40, corresponds to the shaft extension portion 44. The compressor part 20 is provided inside the compressor housing 10. The compressor part 20 is mounted to the end portion on the shaft extension portion 44 side of the base portion 42 of the rotor shaft 40. The compressor part 20 includes a compressor wheel that corresponds to a joint portion with an outer peripheral portion of the rotor shaft 40. The compressor wheel includes a plurality of compressor blades provided on an outer peripheral portion of the compressor wheel.

(Motor Part)

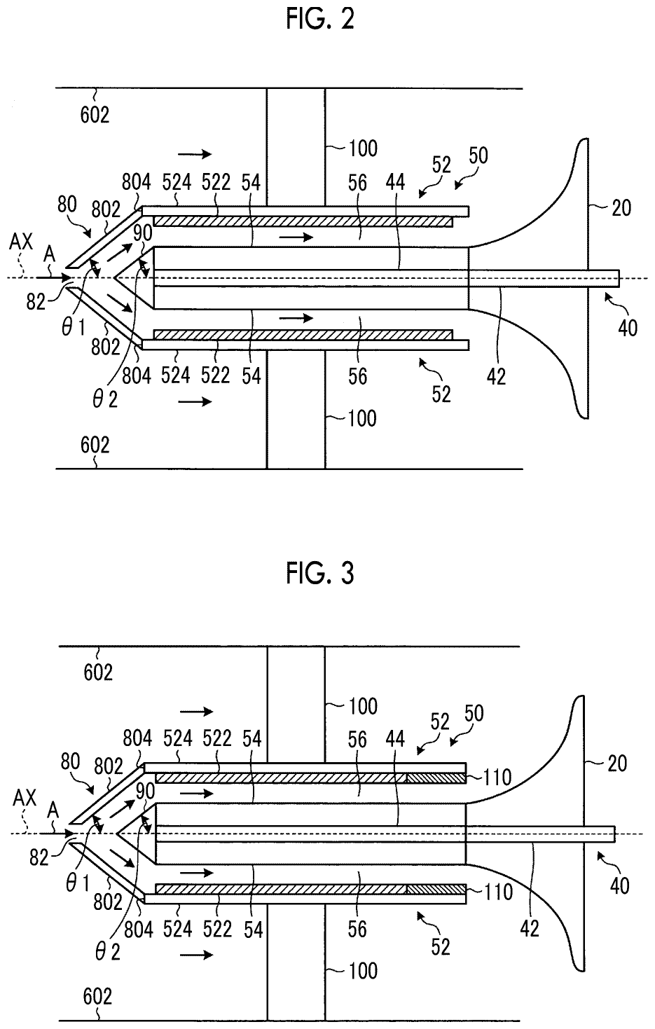

FIG. 2 is a schematic diagram showing a first embodiment of a vibration damping structure according to the present disclosure. As shown in FIG. 1, the motor part 50 is provided in the space SP1 of the compressor housing 10 on the upstream side of the flow of the air A with respect to the location where the compressor part 20 is provided, of the rotor shaft 40. Specifically, the motor part 50 is provided at the shaft extension portion 44 in which the rotor shaft 40 further extends to the upstream side of the air A from a connection location with the compressor part 20. As shown in FIG. 2, the motor part 50 includes a stator part 52 which is a stator, and a rotor part 54 which is a rotor. The rotor part 54 is connected to the shaft extension portion 44. The rotor part 54 may be a columnar member having a permanent magnet provided on an outer peripheral surface of the shaft extension portion 44 of the rotor shaft 40. The stator part 52 is provided so as to surround an outer peripheral portion of the rotor part 54 with a gap 56 between the stator part 52 and the outer peripheral portion of the rotor part 54. The stator part 52 includes a coil 522 in which a conducting wire is wound around an iron core, and a stator housing 524 that covers the coil 522. Copper, aluminum, or the like can be used as the material of the conducting wire. The motor part 50 that includes the stator part 52 and the rotor part 54 is driven by a control device. The control device may be an inverter. The control device generates a magnetic field by applying an alternating-current voltage to the stator part 52, and the magnetic field and the magnetic force of the rotor part 54 act to generate a force in a circumferential direction of the rotor shaft 40 in the rotor part 54, and the rotor shaft 40 to which the rotor part 54 is connected rotates.

Due to the rotation of the motor part 50, the compressor part 20 connected to the rotor shaft 40 is driven, and even if the engine speed is low, sufficient compressed air can be supplied from the electrically assisted turbocharger 1 to the engine.

(Turbine Part)

The turbine part 30 is connected to the end portion on the side opposite to the connection portion with the compressor part 20, of the base portion 42 of the rotor shaft 40. The turbine part 30 includes a turbine wheel that corresponds to a joint portion with the outer peripheral portion of the rotor shaft 40. The turbine wheel includes a plurality of turbine blades provided on an outer peripheral portion of the turbine wheel.

(Vibration Damping Structure of First Embodiment)

As shown in FIG. 2, the electrically assisted turbocharger 1 according to the present disclosure includes a cover part 80 on the upstream side of the air A flowing through the compressor part 20, of the stator part 52. The cover part 80 has an opening portion 82 formed at the end portion on the upstream side of air of the cover part 80. The opening portion 82 makes the gap 56 between the stator part 52 and the rotor part 54 and the location on the upstream side of the air A of the opening portion 82 in the space SP1 communicate with each other in the space SP1.

The specific shape of the cover part 80 will be described. As shown in FIG. 2, the cover part 80 according to the present embodiment has a head portion 802 and a bottom surface portion 804. The stator housing 524 is a tubular member that forms an outer peripheral surface of the stator part 52. That is, the stator housing 524 covers an outer peripheral portion of the coil 522 of the stator part 52. The head portion 802 is provided on the upstream side of the flow of the air A with respect to the gap 56 between the stator part 52 and the rotor part 54. The head portion 802 covers the upstream side of the flow of the air A of the gap 56 between the stator part 52 and the rotor part 54. The head portion 802 may be formed in a conical shape with an apex facing the upstream side of the air A. The height of the cone of the head portion 802 is preferably made large in consideration of a reduction of air resistance. However, the height of the cone is determined in consideration of equilibrium with an adverse effect such as a weight increase due to an increase in the height of the cone. The shape of the cover part 80 is not limited to the conical shape and may be any streamlined shape that is included in a rotating body, such as a water droplet shape or a nose cone shape of a rocket. The bottom surface portion 804, which is the end portion on a bottom surface side of the head portion 802, is connected to the end portion on the upstream side of air of the stator housing 524 that covers the coil 522 of the stator part 52. As the joining method, melt joining such as welding or brazing may be used, or mechanical joining using bolts, rivets, or the like may be used. Further, an integral structure with the stator housing 524 that covers the coil 522 in the stator part 52 is also acceptable.

The opening portion 82 is formed at the position of the apex in the case of the head portion 802 having a conical shape, and makes the gap 56 between the stator part 52 and the rotor part 54 and the location on the upstream side of the air A of the opening portion 82 in the space SP1 communicate with each other. The shape of the opening portion 82 may be a circular hole and may be any polygonal shape such as a triangle, a quadrangle, or a pentagon. The size of the opening portion 82 is large enough to introduce sufficient air into the gap 56 between the stator part 52 and the rotor part 54, and is determined in consideration of equilibrium with the compressed air that is supplied to the engine. Further, the position where the opening portion 82 is formed is not limited to the apex of the head portion 802.

The cover part 80 and the stator housing 524 which are configured as described above do not cover the location on the downstream side in the flow of the air A of the gap 56 and are open. Therefore, the air that has passed through the gap 56 can be compressed by a compressor and supplied to the engine.

A supporting portion 100 is formed on an outer peripheral portion of the stator part 52. The supporting portion 100 is connected to the outer peripheral portion of the stator part 52 and to an intake air introduction path inner peripheral portion 602, which is an inner peripheral portion of the intake air introduction path 60, and supports the stator part 52. A plurality of supporting portions 100 are provided on the outer peripheral portion of the stator part 52. The supporting portions 100 are preferably provided on the outer peripheral portion of the stator part 52 at equal intervals in the circumferential direction of the rotor shaft 40. The cross-sectional shape of the supporting portion 100 is preferably formed into a streamlined shape that suppresses a pressure loss.

(Lid Part)

A lid part 90 is provided at the end portion on the intake air introduction path 60 side of the rotor part 54 inside the compressor housing 10. The lid part 90 covers the entire surface of the end portion on the intake air introduction path 60 side of the rotor part 54. The lid part 90 is preferably formed parallel to the head portion 802 of the cover part 80. That is, in a case where the head portion 802 of the cover part 80 is formed in a conical shape, the lid part 90 is also formed in a conical shape. The lid part 90 that is formed parallel to the head portion 802 is formed at the end portion on the intake air introduction path 60 side of the rotor part 54 that is connected to the shaft extension portion 44 of the rotor shaft 40, so that the air flowing in from the opening portion 82 can be introduced into the gap 56 between the stator part 52 and the rotor part 54 with a pressure loss being suppressed. Therefore, since the pressure of the air in the gap 56 can be increased as compared with a case where the lid part 90 is not provided, it is possible to increase the rigidity of the rotor part 54. Therefore, it is possible to suppress vibration of the rotor part 54 connected to the rotor shaft 40.

However, the lid part 90 is not limited to being formed in a conical shape. As another example of the shape of the lid part 90, an example can be given in which an angle θ2 of the lid part 90 with respect to the axial direction AX is made smaller than an angle θ1 of the head portion 802 of the cover part 80 with respect to the axial direction AX, so that a flow path through which the air flowing in from the opening portion 82 formed in the cover part 80 passes is formed in a shape that expands toward the gap 56 between the stator part 52 and the rotor part 54. Therefore, the air flowing in from the opening portion 82 can be easily introduced into the gap 56 between the stator part 52 and the rotor part 54.

(Operation and Effect of Cover Part)

The air A introduced into the inside of the electrically assisted turbocharger 1 through the intake air introduction path 60 flows horizontally to the rotor shaft 40 in the portion horizontal to the rotor shaft 40 of the intake air introduction path 60. A part of the air A passes through the opening portion 82 formed in the cover part 80. When the air A flowing horizontally to the rotor shaft 40 from the upstream side passes through the opening portion 82, the air flows into the gap 56 between the stator part 52 and the rotor part 54. The air A introduced into the gap 56 applies a fluid force in the direction perpendicular to the rotor shaft 40 to the outer peripheral portion of the rotor part 54. Therefore, since the flow of the air A is formed so as to cover the outer peripheral portion of the rotor part 54, it can be said that a gas bearing using air as a lubricating fluid is formed on the outer peripheral portion of the rotor part 54.

Therefore, since a force in a vertical direction is applied to the outer peripheral portion of the rotor part 54 connected to the shaft extension portion 44 of the rotor shaft 40, a state where rigidity is added to the rotor part 54 connected to the rotor shaft 40 is created, and thus the displacement of the rotor shaft 40, that is, the vibration of the rotor shaft 40, can be suppressed. Further, since the air introduced into the gap 56 has viscosity, when the stator part 52 vibrates in the direction perpendicular to the rotor shaft 40, vibration energy is consumed by the flow of the air A having viscosity in the direction horizontal to the rotor shaft 40 and by the compression in the direction perpendicular to the rotor shaft 40, and thus the effect of attenuating the vibration is exhibited.

Therefore, the cover part 80 having the opening portion 82 is provided, so that the air A can be introduced into the gap 56 between the rotor part 54 and the stator part 52, and therefore, even if the motor part 50 is provided at the end portion of the rotor shaft 40, vibration can be suppressed by the air introduced into the gap 56. Further, since the air introduced into the gap 56 can cool the stator part 52, the efficiency of the motor can be improved.

(Vibration Damping Structure of Second Embodiment)

FIG. 3 is a schematic diagram showing a second embodiment of the vibration damping structure according to the present disclosure.

The second embodiment is common to the first embodiment except that a recess forming portion 110 is added to the first embodiment. The description of portions common to the first embodiment in the second embodiment will be omitted.

As shown in FIG. 3, in the vibration damping structure according to the second embodiment, the recess forming portion 110 is provided at the end portion on the compressor part 20 side of an inner peripheral portion of the stator housing 524. That is, the recess forming portion 110 is provided on the downstream side of the flow of the air A with respect to the coil 522 provided on the inner peripheral portion of the stator housing 524. The recess forming portion 110 is provided so as to surround the outer peripheral portion of the rotor part 54 with a gap having the same size as the gap 56 interposed therebetween. A plurality of recesses are formed in the recess forming portion 110. Hereinafter, the recess forming portion 110 will be described in more detail.

(Recess Forming Portion)

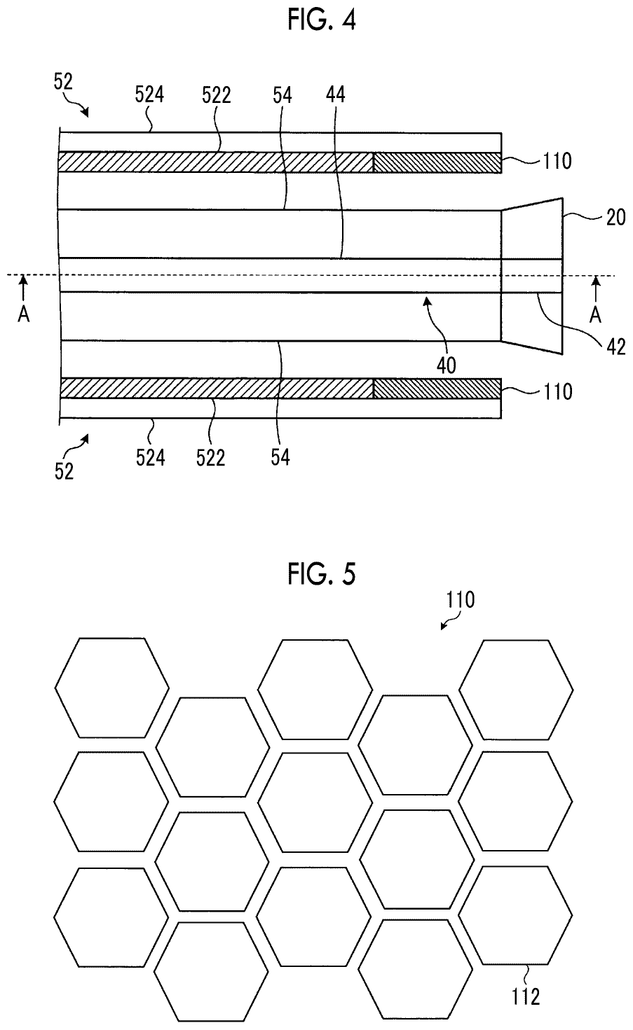

FIG. 4 is a schematic diagram of the recess forming portion that is used in the vibration damping structure according to the present disclosure. As shown in FIG. 4, the recess forming portion 110 according to the present embodiment is provided at the end portion on the compressor part 20 side of the inner peripheral portion of the stator housing 524. The recess forming portion 110 is formed so as to surround the outer peripheral portion of the rotor part 54. A plurality of recesses 112 are formed in an inner peripheral portion of the recess forming portion 110. The recess 112 does not penetrate to the stator housing 524 provided on an outer peripheral surface of the recess forming portion 110. In other words, the recess 112 is formed from an inner peripheral surface of the recess forming portion 110 to an intermediate portion located between the inner peripheral surface and the outer peripheral surface in a radial direction. It is preferable that a sufficient number of recesses 112 are formed to cover the entire surface of the inner peripheral portion of the recess forming portion 110.

The air introduced into the gap 56 between the inner peripheral portion of the stator part 52 and the outer peripheral portion of the rotor part 54 flows through the gap 56 in the direction horizontal to the rotor shaft 40 from the end portion on the intake air introduction path 60 side of the gap 56. When the air introduced into the gap 56 reaches the recess forming portion 110 provided at the end portion on the compressor part 20 side of the inner peripheral portion of the stator part 52, some of the air flows into the recess 112 formed in the recess forming portion 110, so that a pressure loss is generated.

Therefore, it is possible to suppress the outflow of the air introduced into the gap 56 between the stator part 52 and the rotor part 54 from the end portion on the compressor part 20 side of the gap 56. As a result, as compared with a case where the recess forming portion 110 is not provided, the pressure of the air inside the gap 56 increases, so that the load capacity of the gas bearing portion increases and the bearing rigidity increases. Therefore, it is possible to suppress the vibration of the rotor part 54 connected to the rotor shaft 40.

(Honeycomb Shape)

FIG. 5 is a schematic diagram showing a first example of the shape of the recess that is formed in the recess forming portion according to the present disclosure.

As shown in FIG. 5, the first example of the shape of the plurality of recesses 112 which are formed in the recess forming portion 110 is formed in a honeycomb shape. The honeycomb shape is a structure in which regular hexagons or regular hexagonal columns are arranged without gaps. Since the regular hexagon has the shortest circumference among the figures that can be tessellated, it is possible to reduce the number of members that are used. The honeycomb shape of the recess 112 is not limited to a regular hexagon or a regular hexagonal column, and may be a structure in which one selected from polygons such as a triangle, a quadrangle, and a pentagon is arranged. Further, a structure is also acceptable in which a plurality of polygons including a triangle, a quadrangle, a pentagon, a hexagon, and the like are selected and arranged in combination.

By making the shape of the recess a honeycomb shape, it is possible to closely integrate the recesses. Therefore, the air introduced into the gap 56 between the inner peripheral portion of the stator part 52 and the outer peripheral portion of the rotor part 54 can easily flow into the closely integrated honeycomb-shaped recesses 112. A pressure loss is generated by the plurality of recesses 112 formed in the recess forming portion 110, and thus the outflow of air from the end portion on the compressor part 20 side of the stator part 52 can be suppressed. Therefore, since the pressure of the air inside the gap 56 increases, the load capacity of the gas bearing portion increases, and the bearing rigidity increases. It is possible to suppress the vibration of the rotor part 54 connected to the rotor shaft 40.

(Groove Shape)

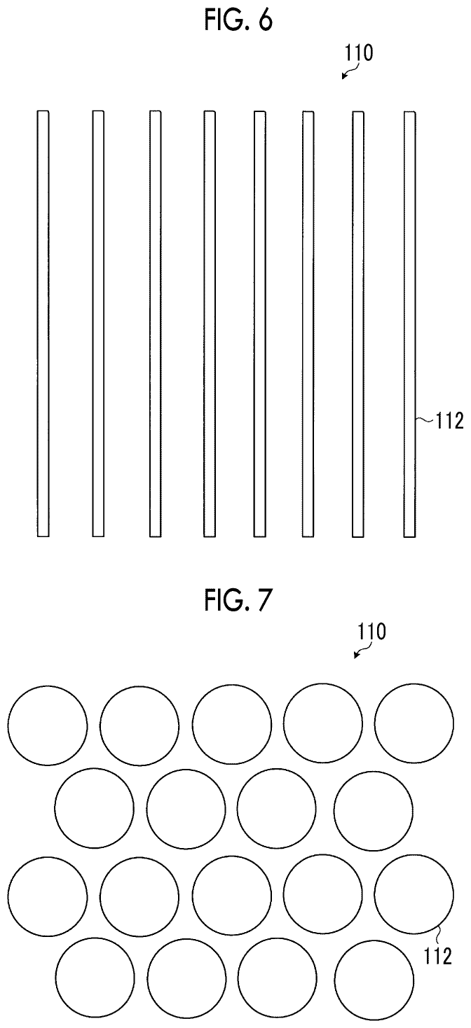

FIG. 6 is a schematic diagram showing a second example of the shape of the recess that is formed in the recess forming portion according to the present disclosure.

As shown in FIG. 6, the second example of the plurality of recesses 112 that are formed in the recess forming portion 110 is formed in a groove shape. It is preferable that a plurality of recesses that are formed in a groove shape are formed in parallel with respect to the direction perpendicular to the rotor shaft 40. The groove-shaped recesses can reduce manufacturing costs compared to the honeycomb-shaped recesses.

The shape of the recess 112 is formed in a groove shape, so that a pressure loss is generated in the air passing through the gap 56 due to the air flowing into the recess 112. Therefore, it is possible to suppress the outflow of the air introduced into the gap 56 from the end portion on the compressor part 20 side of the stator part 52. Therefore, since the pressure of the air inside the gap 56 increases, the load capacity of the gas bearing portion increases, and the bearing rigidity increases. It is possible to suppress the vibration of the rotor part 54 connected to the rotor shaft 40.

(Circular Hole Shape)

FIG. 7 is a schematic diagram showing a third example of the shape of the recess that is formed in the recess forming portion according to the present disclosure.

As shown in FIG. 7, the third example of the plurality of recesses 112 that are formed in the recess forming portion 110 is formed in a circular hole shape. It is preferable that a plurality of recesses 112 that are formed in a circular hole shape are formed on the entire surface of the inner peripheral portion of the recess forming portion 110.

The shape of the recess 112 is formed in a circular hole shape, so that a pressure loss is generated in the air passing through the gap 56 due to the air flowing into the recess 112. Therefore, it is possible to suppress the outflow of the air introduced into the gap 56 from the end portion on the compressor part 20 side of the gap 56 between the stator part 52 and the rotor part 54. Therefore, since the pressure of the air inside the gap 56 increases, the load capacity of the gas bearing portion increases, and the bearing rigidity increases. It is possible to suppress the vibration of the rotor part 54 connected to the rotor shaft 40.

(Configuration and Effect of Rotary Machine)

The rotary machine according to the present disclosure includes the rotor shaft 40, the compressor part 20 that is connected to the rotor shaft 40, the rotor part 54 that is connected to the rotor shaft 40 on the upstream side of the flow of air flowing through the compressor part 20 with respect to the compressor part 20, the stator part 52 that is provided to have the gap 56 from the outer peripheral portion of the rotor part 54, and the cover part 80 that covers the upstream side of the flow of the air of the gap 56 between the stator part 52 and the rotor part 54 and that has the opening portion 82 formed to make the gap 56 and the upstream side of the flow of the air with respect to the gap 56 communicate with each other.

According to this configuration, since the air flowing in from the opening portion formed in the cover part is introduced into the gap between the stator part and the rotor part, a state where a gas bearing is provided for the rotor part is created, and thus the vibration of the rotor part connected to the rotor shaft can be suppressed.

The rotary machine according to the present disclosure further includes the lid part 90 which is provided at the end portion on the upstream side of the flow of the air of the rotor part 54, in which a cross-sectional area becomes smaller toward the upstream side of the flow of the air when in a case where viewed from a flow direction of the air.

According to this configuration, it is possible to suppress a pressure loss with respect to the air flowing in from the opening portion formed in the cover part and to introduce the air into the gap between the stator part and the rotor part. Therefore, since the pressure of the air that is introduced into the gap between the stator part and the rotor part can be increased, the rigidity of the rotor part can be further increased, and the vibration of the rotor part connected to the rotor shaft can be suppressed.

The rotary machine according to the present disclosure further includes the recess forming portion 110 that is provided to have a gap so as to surround the outer peripheral portion of the rotor part 54 on the downstream side with respect to the end portion on the downstream side of the flow of the air of the stator part 52, in which the recess forming portion 110 has a plurality of recesses 112 formed on the inner peripheral surface thereof.

According to this configuration, the air introduced into the gap between the stator part and the rotor part flows into the recess formed in the recess forming portion, and a pressure loss is generated. Therefore, since it is possible to suppress the outflow of the air introduced into the gap between the stator part and the rotor part from the end portion on the compressor part side of the gap between the stator part and the rotor part, the pressure of the air introduced into the gap between the stator part and the rotor part increases. As a result, the rigidity of the rotor part can be further increased, and the vibration of the rotor part connected to the rotor shaft can be suppressed.

The recess that is provided in the recess forming portion 110 included in the rotary machine according to the present disclosure has a honeycomb shape.

According to this configuration, the rigidity of the stator part can be further increased, and the vibration of the rotor part connected to the rotor shaft can be suppressed.

The recess that is provided in the recess forming portion 110 included in the rotary machine according to the present disclosure has a groove shape.

According to this configuration, the rigidity of the stator part can be further increased, and the vibration of the rotor part connected to the rotor shaft can be suppressed.

The recess that is provided in the recess forming portion 110 included in the rotary machine according to the present disclosure has a circular hole shape.

According to this configuration, the rigidity of the stator part can be further increased, and the vibration of the rotor part connected to the rotor shaft can be suppressed.

### REFERENCE SIGNS LIST

1: electrically assisted turbocharger
20: compressor part
30: turbine part
40: rotor shaft
52: stator part
54: rotor part
80: cover part
82: opening portion
100: supporting portion

1. A rotary machine comprising:
a rotor shaft;
a compressor part that is connected to the rotor shaft;
a rotor part that is connected to the rotor shaft on an upstream side of a flow of air flowing through the compressor part with respect to the compressor part;
a stator part that is provided to have a gap from an outer peripheral portion of the rotor part; and
a cover part that covers the upstream side of the flow of the air of the gap between the stator part and the rotor part and that has an opening portion formed to make the gap and a location on the upstream side of the flow of the air with respect to the gap communicate with each other.

2. The rotary machine according to claim 1, further comprising:
a lid part which is provided at an end portion of the rotor part on the upstream side of the flow of the air, and in which a cross-sectional area becomes smaller toward the upstream side of the flow of the air when viewed from a flow direction of the air.

3. The rotary machine according to claim 1, further comprising:
a tubular portion that is provided to have a gap to surround the outer peripheral portion of the rotor part on a downstream side with respect to an end portion of the stator part on a downstream side of the flow of the air,
wherein the tubular portion has a plurality of recesses formed on an inner peripheral surface thereof.

4. The rotary machine according to claim 3, wherein the recess has a honeycomb shape.

5. The rotary machine according to claim 3, wherein the recess has a groove shape.

6. The rotary machine according to claim 3, wherein the recess has a circular hole shape.

7. The rotary machine according to claim 2, further comprising:
a tubular portion that is provided to have a gap to surround the outer peripheral portion of the rotor part on a downstream side with respect to an end portion of the stator part on a downstream side of the flow of the air,
wherein the tubular portion has a plurality of recesses formed on an inner peripheral surface thereof.
